(19) United States
(12) Patent Application Publication
(10) Pub. No.: US 2011/0197227 A1
(43) Pub. Date: Aug. 11, 2011

(54) SYSTEMS AND METHODS FOR PROVIDING ROAMING VIDEO WANTED LIST AND ROAMING VIDEO PREFERENCES

(76) Inventors: Alan Rouse, Lawrencevill, GA (US); Charles Dasher, Lawrenceville, GA (US)

(21) Appl. No.: 12/776,788

(22) Filed: May 10, 2010

Related U.S. Application Data
(63) Continuation-in-part of application No. 12/704,243, filed on Feb. 11, 2010, now abandoned.

(51) Int. Cl. G06F 13/00; H04N 7/173

(52) U.S. Cl. 725/38; 725/116

(57) ABSTRACT

Various embodiments of the present invention relate to systems and methods for providing a roaming video wanted list and roaming video preferences. In particular embodiments, the systems and methods provide a first video service provider with a video wanted list and/or video preferences for a subscriber of a second video service provider so that the first video service provider can identify content available on the first video service provider's system that is listed on the subscriber's wanted list and/or is based on video preferences for the subscriber.

This application is a continuation-in-part of U.S. application Ser. No. 12/704,243, filed Feb. 11, 2010 now pending, the disclosure of which is incorporated herein by reference.

### BACKGROUND OF THE INVENTION

1. Field of the Invention

The disclosed invention generally relates to systems and methods for providing a roaming video wanted list and roaming video preferences, and more specifically, to systems and methods to provide a first video service provider with a video wanted list and/or video preferences for a subscriber of a second video service provider so that the first video service provider can identify content available on the first video service provider's system that is listed on the subscriber's wanted list and/or is based on video preferences for the subscriber.

2. Description of the Related Art

Subscribers of a video service provider (such as a cable service provider) will often times subscribe to various services provide by the provider. For example, one such service is video on demand (VOD), which provides individual subscribers a variety of content from which an individual subscriber can select a particular content (such as a movie) for viewing, and the service provider streams the content to the individual subscriber at a time convenient to the subscriber. This content may be provided at no additional cost by the service provider, provided as part of a subscription service (fixed fee) to the subscriber, or provided for a prescribed time (fee per use). To select VOD content, the subscriber searches through a catalog of available content, selects one of the content items, agrees to payment terms if applicable, and then watches the content.

Typically, these services are only available to a subscriber at the subscriber's home (e.g., cable television) or to a particular network coverage area (e.g., video to mobile phone). For instance, a subscriber's VOD service is typically provided at the subscriber's home through a single service provider. Therefore, if a subscriber is not at home, he or she cannot make use of this service.

Further, in particular instances, it may be advantage to have a subscriber's preferences and/or a subscriber's “wanted list” of content the subscriber may wish to view available outside the bounds of the subscriber's home, like for example, when the subscriber is roaming on a foreign service provider's system. Therefore, a need exists to provide a subscriber of a first service provider a roaming video wanted list and/or roaming preferences when the subscriber is roaming on a second service provider's system.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a flow diagram illustrating the process for providing a roaming video wanted list and/or roaming subscriber preferences according to various embodiments of the invention.

FIG. 2 is a schematic diagram illustrating a system for practicing aspects of the invention according to various embodiments of the invention.

FIG. 3 is a schematic diagram illustrating a server model according to various embodiments of the invention.

FIG. 4 is a schematic diagram illustrating a client model according to various embodiments of the invention.

FIG. 5 is a schematic diagram illustrating a home service provider server according to various embodiments of the invention.

FIG. 6 is a flow diagram of a subscriber profile module according to various embodiments of the invention.

FIG. 7 is a flow diagram of a retrieve subscriber wanted list/preferences module according to various embodiments of the invention.

FIG. 8 is a flow diagram of a foreign service provider module according to various embodiments of the invention.

FIG. 9 is a flow diagram of a mobile device module according to various embodiments of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Like numbers refer to like elements throughout.

As should be appreciated, the embodiments may be implemented in various ways, including as methods, apparatus, systems, or computer program products. Accordingly, the embodiments may take the form of an entirely hardware embodiment or an embodiment in which a processor is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions, stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various-combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### BRIEF OVERVIEW OF AN EMBODIMENT

Various embodiments of the present invention provide a roaming video wanted list and roaming video preferences for a subscriber of a first service provider (e.g., home service provider) that facilitates the subscriber viewing content available through a second service provider (e.g., foreign service provider) based on the roaming video wanted list and roaming video preferences. “Content” is a particular piece of media. For instance, content may be a television program and/or a movie. A “roaming video wanted list” (“wanted list”) comprises a listing of content that a subscriber may have identified interest in viewing and/or a list of content predicted the subscriber may have an interest in viewing. The subscriber's “roaming video preferences” (“preferences”) comprise characteristics used to identify content the subscriber may be interested in viewing. For example, the subscriber's preferences may include information that the subscriber prefers comedies. Thus, in various embodiments, this information may be used to identify comedies (e.g., television programs and/or movies) the subscriber may be interested in viewing.

Furthermore, the term “provider” is used from this point forward to indicate a cable service provider, a satellite TV provider, or any other provider of distributed video content including cellular based providers. The term “subscriber” is used to describe a person (or entity) that subscribes to one or more services provided by a service provider, such as a cable service provider or a satellite TV provider. The term “home service provider” is used to reference a service provider that provides a subscriber with video content while the subscriber is typically at home or at a location the subscriber receives his or her subscribed-to services. That is, the home service provider typically has a business relationship with the subscriber to provide video content services to the subscriber. The term “foreign service provider” is used to reference a service provider that does not provide the subscriber with video content while the subscriber is typically at home or at the location where the subscriber receives his or her subscribed-to services.

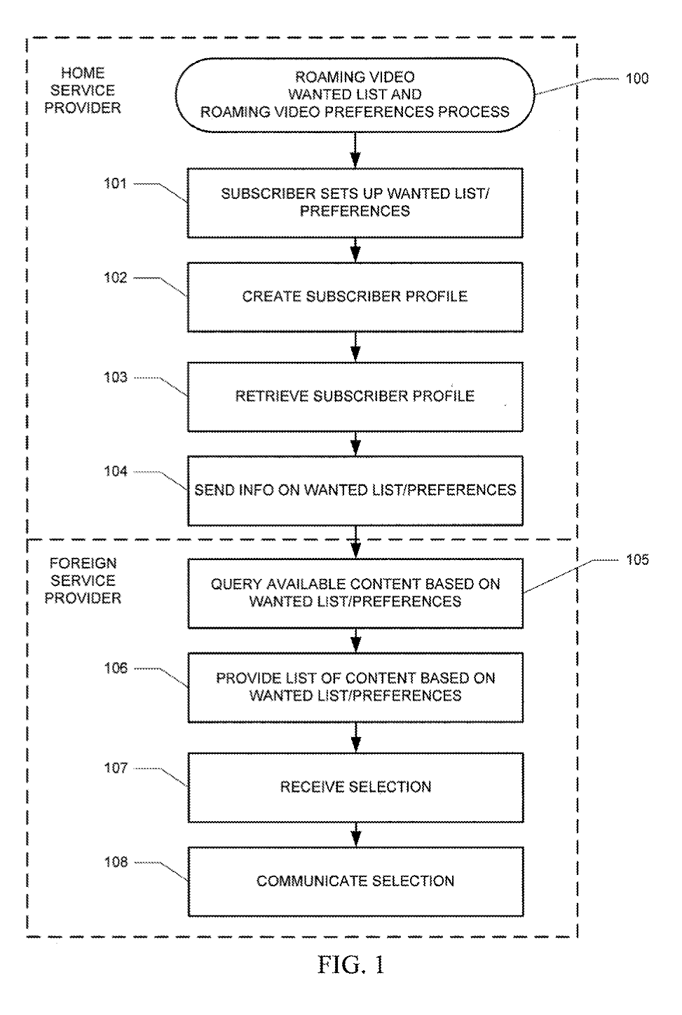

FIG. 1 illustrates one embodiment of a flow diagram of a process 100 for providing a subscriber with a roaming video wanted list and/or roaming video preferences. For instance, a subscriber of a particular service provider (e.g., home service provider) may be traveling and staying at a relative's home. During the stay, the subscriber may be staying in a room with a television and may wish to see what programming is available that is of interest to the subscriber. Further, the relative may be receiving cable service from a different service provider (e.g., foreign service provider). Thus, if the subscriber has a wanted list and/or preferences that may be used to identify programming of interest for the subscriber set up with the subscriber's home service provider, the subscriber is unable to make use of the list and preferences at the relative's home. However, various embodiments of the invention address this issue by providing the subscriber with a roaming wanted list and/or preferences.

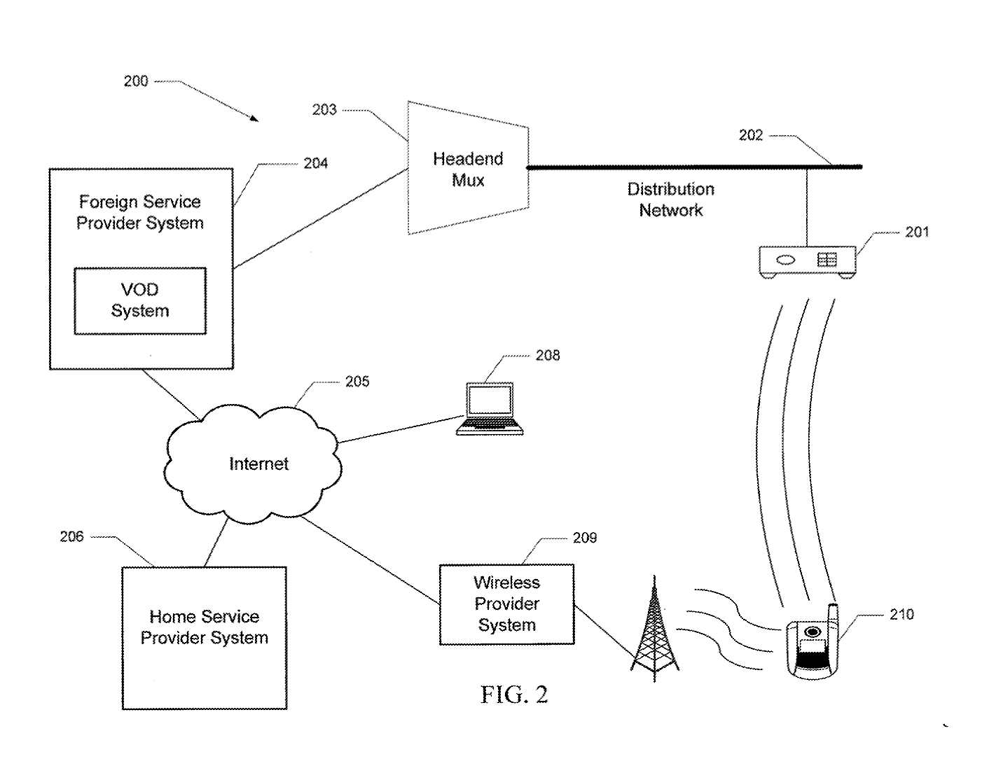

First, in various embodiments, the home service provider may enter into arrangements (e.g., business relationships) with the foreign service provider that define the necessary system components (e.g., hardware and software) and communication channels needed to practice various aspects of the invention. Further details for the necessary components and communication channels are provided below in FIG. 2 according to a particular embodiment of the invention. In addition, in various embodiments, the home service provider and/or the foreign service provider may enter into arrangements (e.g., business relationships) with other parties to facilitate various aspects of the invention. For instance, in one embodiment, the home service provider and/or foreign service provider may enter into a business relationship with one or more wireless providers to facilitate communication with subscribers and/or with each other.

Returning to FIG. 1, in various embodiments, the subscriber first sets up a wanted list and/or preferences with his or her home service provider, shown as Step 101. This may entail the subscriber entering information, such as content the subscriber may wish to view and/or preferences for types of content, through a service provided by the home service provider (such as VOD service) or through a website associated with the home service provider. Further, in various embodiments, this may entail the home service provider monitoring and recording the viewing history of the subscriber to establish content to add to the wanted list and/or to establish preferences.

In Step 102, the home service provider creates a profile for the subscriber. In particular embodiments, the profile includes information on the subscriber's wanted list and/or on the subscriber's preferences. The home service provider may update the subscriber's profile based on additional information provided by the subscriber and/or content viewed by the subscriber.

Thus, returning to the example, the subscriber visiting his or her relative invokes the VOD service through the set-top box connected to the relative's television. The set-top box is provided by the foreign service provider and deliver's the relative's cable service. Further, in various embodiments, an option is provided in the VOD service for a subscriber to request his or her wanted list and/or preferences be retrieved from his or her home service provider. In this case, the subscriber selects the option and a list of various service providers is shown for the subscriber to select from, according to one embodiment. The subscriber scans through the list and selects his or her home service provider from the list.

In various embodiments, the subscriber is prompted for identification information, such as a username and/or an account number and/or a password. The subscriber enters the information by utilizing various input devices such as a remote control or a keyboard in communication with the set-top box. In response, the set-top box directs the identification information over the foreign service provider's distribution network to the headend associated with the network. The headend directs the identification information through the foreign service provider's system along with a request for the subscriber's wanted list and/or preferences to the home service provider's system. For instance, in one embodiment, the foreign service provider's system is in communication with the home service provider's system over the Internet and the request is routed over the Internet to the home service provider's system.

The home service provider's system receives the request along with the identification information and retrieves the subscriber's profile, shown as Step 103. This step may be carried out in different ways according to various embodiments. For instance, the home service provider's system retrieves the subscriber's profile by utilizing the subscriber's identification information.

Thus, in Step 104, once the home service provider's system retrieves the subscriber's profile, the system sends the subscriber's wanted list and/or preferences to the foreign service provider's system. For instance, the home service provider's system sends information on the wanted list and/or preferences over the Internet to the foreign service provider's system. In response, in Step 105, the foreign service provider's system queries content available through the foreign service provider based on the subscriber's wanted list and/or preferences. For instance, the foreign service provider may query its available broadcast programming and/or VOD programming. For example, the foreign service provider's system may query its VOD library to identify available VOD content (such as movies and/or television programs) that is found on the subscriber's wanted list. Once the foreign service provider's system has obtained a subset of the available content based on the subscriber's wanted list and/or preferences, the foreign service provider's system provides the subset (e.g., listing) of the available content to the subscriber, shown as Step 106. For example, the foreign service provider's system streams the listing of available content over the foreign provider's distribution network to the set-top box connected to the relative's television. In response, the set-top box provides one or more menus that are displayed on the television.

The subscriber is then able to browse the content listing and select a desired content to view. A request to view the particular content is forwarded to the foreign service provider's system and the system receives the subscriber's selection, shown as Step 107. In response, in various embodiments, the foreign service provider's system facilitates streaming the selection content to the set-top box so that the subscriber may view the content. Further, in various embodiments, the foreign service provider's system also communicates the subscriber's selection to the home service provider's system, shown as Step 108. In particular embodiments, the home service provider's system may then update and/or revise the subscriber's profile based on the selection.

As a result of the process 100, the subscriber is able to view what content is available that may be of interest to the subscriber while not at home and at another individual's home. It should be apparent to one of ordinary skill in the art that the above-described process 100 is provided as an example only and that the process 100 can be used in various other situations. For example, the subscriber may be located in an airport and the foreign service provider may be a kiosk service that provides monitors in the airport for individuals. In this particular instance, the foreign service provider may use the subscriber's wanted list and preferences in a similar fashion as explained above so that the subscriber can view desired programming while waiting in the airport. In other examples, the subscriber may be requesting programming for radio from a foreign satellite provider. The subscriber may also be using a portable device (such as a laptop computer or an iPhone®) and may access a foreign service provider through the Internet or an application loaded on the portable device. Thus, the description of the process 100 provided above is for illustrative purposes only and should not be construed to limit the scope of the invention.

### System Architecture

A system 200 for, practicing aspects of the invention according to various embodiments is shown in FIG. 2. As may be understood from this figure, in various embodiments, the system 200 includes more than one service providers' system. The particular embodiment shown in FIG. 2 includes a foreign service provider system 204 and a home service provider system 206. As is described in further detail below, the foreign service provider system 204 is the provider system through which a subscriber of the home service provider system 206 may request to view content from the subscriber's roaming video wanted list and/or roaming video preferences. For example, in one embodiment, the foreign service provider and the home service provider may be providers of cable television programming. However, in another embodiment, the foreign service provider and the home service provider may be providers of satellite television programming. Still, in another embodiment, the foreign service provider and the home service provider may be some other type of multimedia providers such as a wireless provider, an Internet provider, or a combination of the various types of providers described above. However, for purposes of illustrating the various embodiments of the invention, both the foreign service provider and the home service provider are cable television providers. Therefore, it should be understood that the system 200 depicted in FIG. 2 is provided for illustrative purposes only and should not be construed to limit the scope of the invention.

In FIG. 2, the foreign service provider system 204 is in communication with a headend 203 and the headend 203 is in communication with a distribution network 202. In various embodiments, the distribution network 202 includes one or more set-top boxes 201. In general, the set-top box 201 is a device that is used by a subscriber to receive digital cable signals for television and is configured to send data to the headend 203 of the foreign service provider system 204. For example, the set-top box 201 may be a device, such as a personal video recorder (PVR) provided by a cable company. The PVR receives the digital cable signal and feeds the signal into an individual's television set so that the individual can view the cable company's cable television programming.

As shown, in various embodiments, the set-top box 201 communicates with the headend 203 of the foreign service provider system 204 over the distribution network 202. The headend 203 routes messages (e.g. subscriber requests) received from the set-top box 201 to various components of the foreign service provider system 204 and streams content (e.g., programs and movies) to the set-top-box 201. For instance, in one embodiment, the headend 203 receives input from the user via the set-top box 201, interprets the input, and routes the input to the appropriate component of the foreign service provider system 204, such as the VOD system.

Further, in various embodiments, the foreign service provider system 204 and the home service provider system 206 are connected over a communication channel. For instance, in FIG. 2, the foreign service provider system 204 and the home service provider system 206 are connected over the Internet 205. Further, in various embodiments, the two service provider systems 204, 206 may make use of security measures such as a virtual private network (VPN) or encryption to communicate. However, it should be obvious to those of ordinary skill in the art, in light of this disclosure, that the two service provider systems 204, 206 may use other channels of communication in other embodiments, such as a local area network (LAN), a wide area network (WAN), or a wireless network.

As depicted in FIG. 2, the system 200 may also include other provider systems such as a wireless provider system 209. As is described in greater detail below, the wireless provider system 209 may be utilized in various embodiments to provide a video wanted list and/or video preferences for a subscriber of the home service provider to the foreign service provider system 204. For instance, in one embodiment, the subscriber transmits the wanted list and/or preferences residing on the subscriber's wireless device 210 (such as a cell phone) to the foreign service provider system 204. In another embodiment, the subscriber's wireless device 210 may communicate directly with the set-top box 201 to transmit the wanted list, such as, for example, through infrared or Bluetooth® technology.

In other embodiments, the system 200 may also include a personal computer 208 or laptop computer through which a subscriber can set up his or her wanted list over the Internet 209 with the subscriber's home service provider. For instance, the home service provider system 206 may host a website and the subscriber logs onto the website to register/record a wanted list with the home service provider system 206.

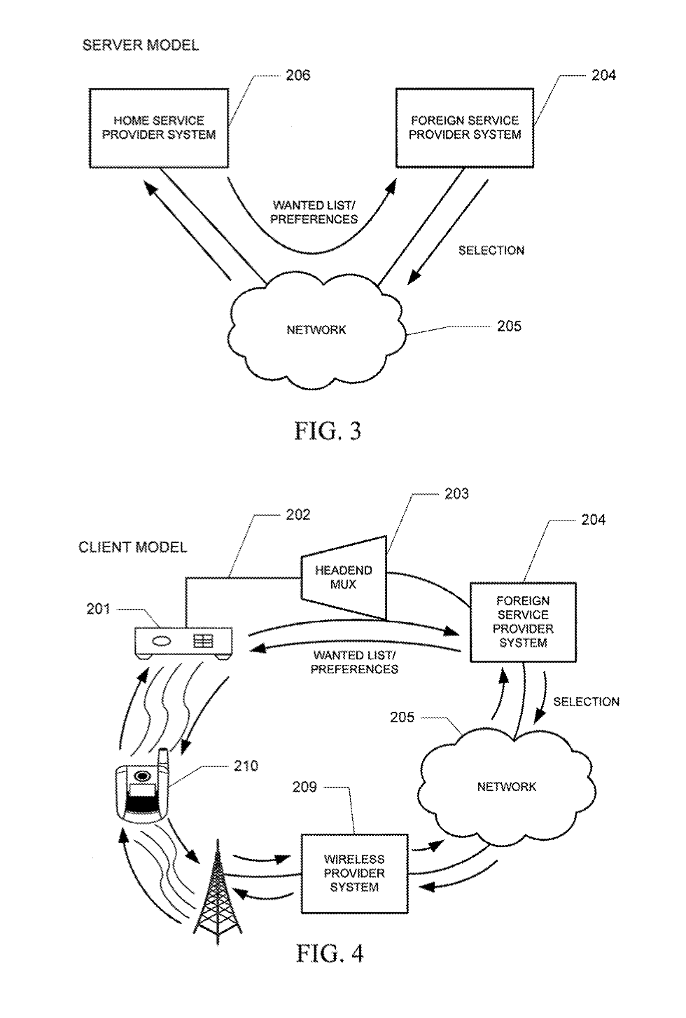

As briefly mentioned above, in various embodiments of the invention, a subscriber's wanted list and/or preferences may be communicated to the foreign service provider system 204 from the subscriber's home service provider system 206 (e.g., server model) and/or from a device 210 used by the subscriber (e.g., client model). FIG. 3 demonstrates communicating the subscriber's wanted list and/or preferences via a server model according to one embodiment of the invention. In this embodiment, the home service provider system 206 sends the subscriber's wanted list and/or preferences to the foreign service provider system 204 over a network 205 such as the Internet. As is described in greater detail below, the foreign service provider identifies available content on its system 204 based on the subscriber's wanted list and/or preferences. The subscriber can then select from the identified content to view through the foreign service provider system 204. In response to selecting content, in various embodiments, the foreign service provider system 204 communicates the subscriber's selection back over the network 205 to the subscriber's home service provider system 206. As a result, in various embodiments, the home service provider system 206 updates/revises the subscriber's wanted list and/or preferences based on the subscriber's selection.

Further, FIG. 4 demonstrates communicating the subscriber's wanted list and/or preferences via a client model according to one embodiment of the invention. In this embodiment, a device 210 used by the subscriber (such as the subscriber's cell phone) transmits the subscriber's wanted list and/or preferences to the foreign service provider system 204. For instance, in one embodiment, the subscriber's device 210 transmits the wanted list and/or preferences wirelessly to a set-top box 201 in communication with the foreign service provider system 204. In this particular embodiment, the subscriber's device 210 may transmit the wanted list and/or preferences via Bluetooth®, infrared, and/or Wi-Fi® to the set-top box 201. In response, in particular embodiments, the set-top box 201 may transmit the subscriber's wanted list and/or preferences over the foreign service provider's distribution network 202 to the foreign service provider's headend 203 and the headend 203 directs the wanted list and/or preferences to the foreign service provider system 204.

In another embodiment, the subscriber's device 210 transmits the subscriber's wanted list and/or preferences over a wireless provider's system 209 and the wireless provider's system 209 transmits the wanted list and/or preferences over a network 205 (such as the Internet) to the foreign service provider system 204. Yet, in another embodiment, the subscriber's device 210 signals the wireless provider's system 209 to send the subscriber's wanted list and/or preferences to the foreign service provider system 204. For instance, the subscriber's device 210 sends a message over the wireless provider's network to send the subscriber's wanted list and/or preferences along with an identifier that identifies the foreign service provider. In response, the wireless provider's system 209 may retrieve the subscriber's wanted list and/or preferences from storage media under control of the wireless provider or may request the wanted list and/or preferences from the subscriber's home service provider. Once retrieved, the wireless provider's system 209 sends the subscriber's wanted list and/or preferences over the network 205 to the foreign service provider system 204. Similar to the server model, in various embodiments, the foreign service provider system 204 may send any selections made by the subscriber through the foreign servicer provider back to the wireless provider's system 209 so that the subscriber's wanted list and/or preferences may be updated/revised.

### Exemplary Home Service Provider System

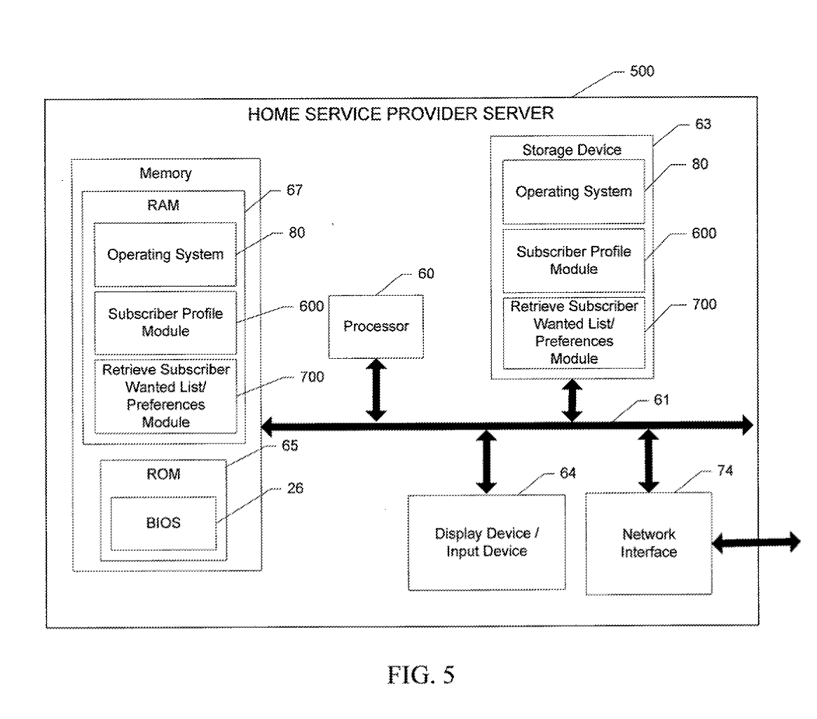

The home service provider system 206 depicted in FIG. 2 may be comprised of several components according to various embodiments. For instance, in one embodiment, the system 206 may comprise one or more servers and one or more storage medium. In particular, FIG. 5 shows a schematic diagram of a server 500 that may reside in the home service provider system 206 according to one embodiment of the invention. However, it should be understood that the home service provider system 206 does not necessarily need to include only a single server. For instance, in various embodiments, the system 206 may include one or more servers executing one or more software applications. Thus, the server 500 shown in FIG. 5 is provided for illustrative purposes only and should not be construed to limit the scope of the invention.

In FIG. 5, the server 500 includes a processor 60 that communicates with other elements within the server 500 via a system interface or bus 61. Also connected to the server 500 is a display device/input device 64 for receiving and displaying data that may be used by administrative personnel. This display device/input device 64 may be, for example, a keyboard or pointing device that is used in combination with a monitor. The server 500 further includes memory 66, which preferably includes both read only memory (ROM) 65 and random access memory (RAM) 67. The server's ROM 65 is used to store a basic input/output system 26 (BIOS), containing the basic routines that help to transfer information between elements within the server 500. Alternatively, the server 500 can operate on one computer or on multiple computers that are networked together.

In addition, the server 500 includes at least one storage device 63, such as a hard disk drive, a floppy disk drive, a CD Rom drive, flash drive, or optical disk drive, for storing information on various computer-readable media, such as a hard disk, a removable magnetic disk, or a CD-ROM disk. As will be appreciated by one of ordinary skill in the art, each of these storage devices 63 is connected to the server bus 61 by an appropriate interface. The storage devices 63 and their associated computer-readable media provide nonvolatile storage for the server 500. It is important to note that the computer-readable media described above could be replaced by any other type of computer-readable media known in the art. Such media include, for example, magnetic cassettes, flash memory cards, digital video disks, and Bernoulli cartridges.

A number of program modules (e.g., set of computer program instructions) may be stored by the various storage devices and within RAM 67. For example, as shown in FIG. 5, program modules of the server 500 may include an operating system 80, a subscriber profile module 600, and a retrieve subscriber wanted list/preferences module 700. These modules 600, 700 may be used to control certain aspects of the operation of the server 500, as is described in more detail below, with the assistance of the processor 60 and an operating system 80.

Also located within the server 500 is a network interface 74, for interfacing and communicating with other elements of one or more networks (such as the network 205 described in the system 200 depicted in FIG. 2.) It will be appreciated by one of ordinary skill in the art that one or more of the server's 500 components may be located geographically remotely from other server 500 components. Furthermore, one or more of the components may be combined, and additional components performing functions described herein may be included in the server 500.

### Additional Exemplary System Components

The foreign service provider system 204 and the wireless provider system 209 may each include one or more servers with components and functionality similar to that of the home service provider server 500. For example, in one embodiment, each of the systems 204, 209 include one or more servers that may include: (1) a processor that communicates with other elements via a system interface or bus; (2) a display device/input device; (3) memory including both ROM and RAM; (4) a storage device; and (5) a network interface. These architectures are provided for exemplary purposes only and are not limiting to the various embodiments. The term “server” is used generically to refer to any computer, computing device, desktop, notebook or laptop, distributed system, server, gateway, switch, or other processing device adapted to perform the functions described herein.

### Exemplary System Operation

As mentioned above, the system 200 according to various embodiments provides a subscriber of a first service provider (e.g., home service provider) with a wanted list and/or preferences that may be used to identify content that is available through a second service provider (e.g., foreign service provider). In various embodiments, the home service provider's system 206 may include a subscriber profile module 600 and a retrieve subscriber wanted list/preferences module 700. Further, in various embodiments, the foreign service provider system 204 may include a foreign service provider module 800. In addition, in various embodiments, a subscriber's device may include a mobile device module 900. These modules 600, 700, 800, 900 are configured to control certain aspects of the claimed invention as described in more detail below.

### Subscriber Profile Module

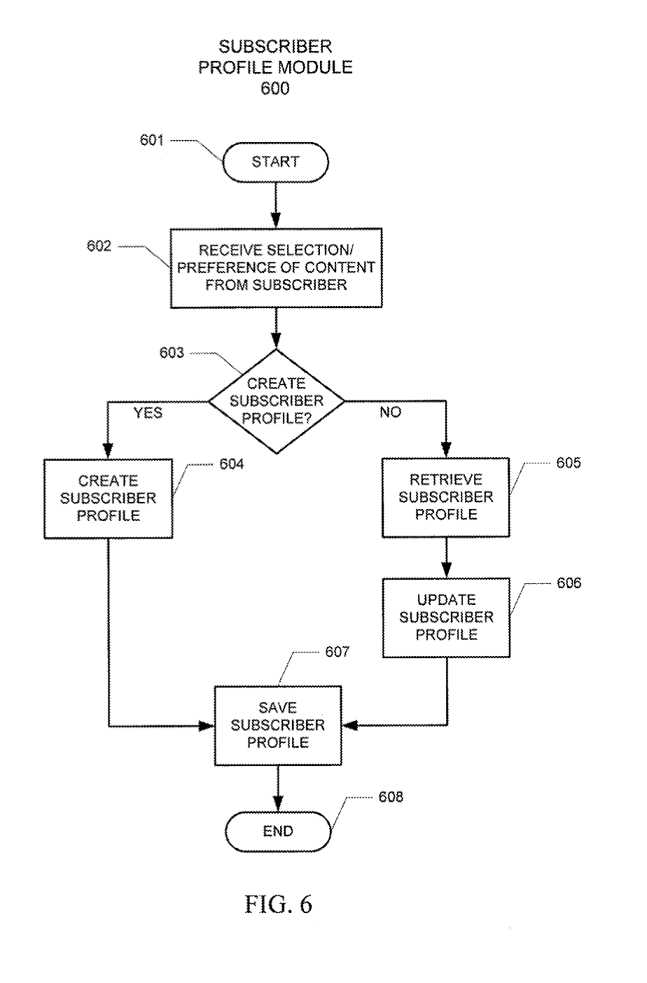

In various embodiments, the home service provider system 206 includes a subscriber profile module 600 that is adapted to facilitate creating and/or updating/revising a subscriber profile for a particular subscriber of the home service provider. This subscriber profile may include information on a wanted list of content the subscriber has an interest in viewing and/or content predicted that the subscriber may have an interest in viewing. Further, the subscriber profile may include information on preferences of the subscriber for content based on information provided by the subscriber and/or information collected on the subscriber's viewing habits. In particular embodiments, a subscriber profile may comprise one or more files and/or one or more records stored in a database. The one or more files and/or one or more records may contain the information on the subscriber's wanted list and/or preferences. In addition, in particular embodiments, the one or more files and/or the one or more records may contain information that identifies a subscriber's profile and/or the storage location of a subscriber's profile. Accordingly, FIG. 6 illustrates a flow diagram of a subscriber profile module 600 according to various embodiments. This flow diagram may correspond to the steps carried out by the processor 60 in the home service provider server 500 shown in FIG. 5 as it executes the module 600 in the server's RAM memory 67 according to various embodiments.

In various embodiments, the subscriber may enter one or more selections of content that the subscriber would like to view (e.g., the subscriber may enter one or more titles of content and/or identifiers of content). For example, the subscriber may wish to add the Harry Potter movies to a wanted list that includes content that the subscriber would like to view. In one embodiment, the subscriber may add these movies (e.g., movie titles and/or movie identifiers) through the subscriber's set-top box. For instance, in this particular embodiment, the subscriber may access the video-on-demand (VOD) service provided by the subscriber's home service provider via a remote control through the subscriber's set-top box. The VOD service may provide an option that allows the subscriber to select and/or enter content titles to add to the subscriber's wanted list. Thus, the subscriber may use his or her remote control and review the available content on the home service provider's system 206 and select content titles to add to the subscriber's wanted list. Further, in particular embodiments, the subscriber may type in a title of a particular content using his or her remote control to add to the subscriber's wanted list.

In addition, in various embodiments, the subscriber may identify preferences for content. For instance, in one embodiment, the subscriber may be asked a series of questions via the home service provider's VOD service that identify preferences of content for the subscriber, such as types of movies/programs the subscriber prefers (such as Westerns, comedies, and/or love stories), favorite actors, and/or favorite movies/television programs. In addition, in various embodiments, the subscriber's preferences may include past content the subscriber has viewed and/or information on past content the subscriber has viewed (e.g., viewing history). For instance, the subscriber may view a sitcom and preference information based on the sitcom may be stored in the subscriber's profile, such as the title of the sitcom and/or information that the subscriber has viewed a comedy. Further, in particular embodiments, the home service provider's system 206 may derive preferences for the subscriber based on the subscriber's viewing history. In addition, in particular embodiments, the home service provider's system 206 may identify content titles that the system 206 predicts the subscriber may have an interest in viewing based on the subscriber's selection of content titles, the subscriber's preferences, and/or the subscriber's viewing history.

In various embodiments, the subscriber may enter content selections and/or preferences via a website provided by the home service provider. For instance, in one embodiment, the subscriber may log onto a website provided by the home service provider over the Internet. The website may provide one or more Web pages that the subscriber uses to identify content to add to the subscriber's wanted list and/or preferences for content.

As a result, the subscriber's set-top box and/or the website transmit the identified content and/or preferences to the subscriber profile module 600. Thus, in Step 602, the module 600 receives a selection of content and/or preferences for content from the subscriber. In Step 603, the subscriber profile module 600 determines whether a subscriber profile should be created for the particular subscriber. For instance, in one embodiment, an identifier that identifies the subscriber is sent along with the information on the identified content and/or preferences to the subscriber profile module 600. In this particular embodiment, the subscriber profile module 600 queries one or more storage media using the subscriber identifier to determine whether a subscriber profile already exists for the subscriber. For example, a database may reside in the storage media that includes information on profiles created for subscribers of the home service provider. Each one of the profiles may be associated with a subscriber identifier that identifies the particular subscriber for the particular profile.

Thus, if the query does not return an indicator (e.g., a profile identifier) that a profile already exists for the subscriber, the subscriber profile module 600 creates a profile for the subscriber, shown as Step 604. In particular embodiments, this entails the subscriber profile module 600 creating one or more files and/or one or more records that may be stored in a database that represent the subscriber's profile. In this particular instance, the subscriber profile module 600 also saves the information on the selections and/or preferences of content received from the subscriber in the one or more files and/or the one or more records created for the subscriber. Therefore, in Step 607, the subscriber's profile is saved along with the information on the selections and/or preferences of content.

If the query does return an indicator (e.g., a profile identifier) that a profile already exists for the subscriber, the subscriber profile module 600 retrieves the subscriber's profile, shown as Step 605. For instance, in one embodiment, the subscriber profile module 600 uses the profile identifier to retrieve the one or more files and the one or more records associated with the profile identifier from the storage media.

In Step 606, the subscriber profile module 600 updates the subscriber's profile based on the information received on the selection and/or preferences of content. As previously described, the information may identify particular content that is or is not available on the home service provider's system. For example, the subscriber may have selected a Harry Potter movie that is currently available through the home service provider's VOD service. This movie may be identified in the information received from the subscriber by a movie identifier that is unique to the home service provider or that is universal among service providers. That is, in various embodiments, each movie (or content item) is identified by a universal identifier that is made public to all service providers and/or that is agreed to between two or more service providers. In particular instances, this universal identifier may be assigned to a content item by the production company and/or the distribution company of the content. Thus, in particular embodiments, a service provider can identify a particular content by using the content's universal identifier. Thus, the subscriber profile module 600 may save the universal identifiers in the subscriber's profile for identified content. As a result, in various embodiments, a foreign service provider can easily identify a content found in a subscriber's profile (e.g., on a subscriber's wanted list) using the content's universal identifier.

Once the subscriber profile module 600 has updated the subscriber's profile, the module 600 saves the subscriber's profile in the storage media, shown as Step 607. Thus, as previously described, in various embodiments, the subscriber profile module 600 saves the updated profile in the one or more files and one or more records associated with the subscriber's profile. As is described in greater detail below, this profile is used in various embodiments to identify available content in a foreign service provider's system 204 that the subscriber may view through the foreign service provider's system 204.

### Retrieve Subscriber Wanted List/Preferences Module

In particular embodiments, the subscriber may be located in a different location other than where he or she normally receives content from his or her subscribed-to content provider (e.g., home service provider). For example, the subscriber may reside in Atlanta, Ga. and may be visiting a friend in Chicago, Ill. While in Chicago, the subscriber may wish to see want content is available through the friend's service provider that may be of interest to the subscriber. The friend's service provider may be the same service provider the subscriber subscribes to at home or may be a different provider. However, for purposes of this illustration, the friend's service provider is a different service provider (e.g., foreign service provider) than the subscriber's service provider at home (e.g., home service provider).

In various embodiments, the subscriber accesses the VOD service of the foreign service provider on a set-top box 201 located at the friend's home. For instance, in one embodiment, the subscriber turns on a television located at the friend's home and signals the set-top box 201 attached to the television to invoke the VOD service by selecting one or more buttons on a remote control in communication with the set-top box 201. In this particular instance, the VOD service may include an option that allows for the subscriber to retrieve his or her wanted list and/or preferences and to have the foreign service provider identify content available through its system 204 based on the subscriber's wanted list and/or preferences. Thus, in this particular embodiment, the subscriber invokes the option. In particular embodiments, the option may request the subscriber to enter information to identify the subscriber and the subscriber's home service provider. For instance, the subscriber may enter the subscriber's name and/or an identifier that identifies the particular subscriber.

In response, the set-top box 201 sends a message over the foreign service provider's distribution network 202 to the foreign service provider system 204. The foreign service provider system 204 then sends a message to the subscriber's home service provider system 206 to request the subscriber's wanted list and/or preferences. For instance, in one embodiment, the foreign service provider system 204 sends the message over the Internet 205 and the message is received by the home service provider system 206.

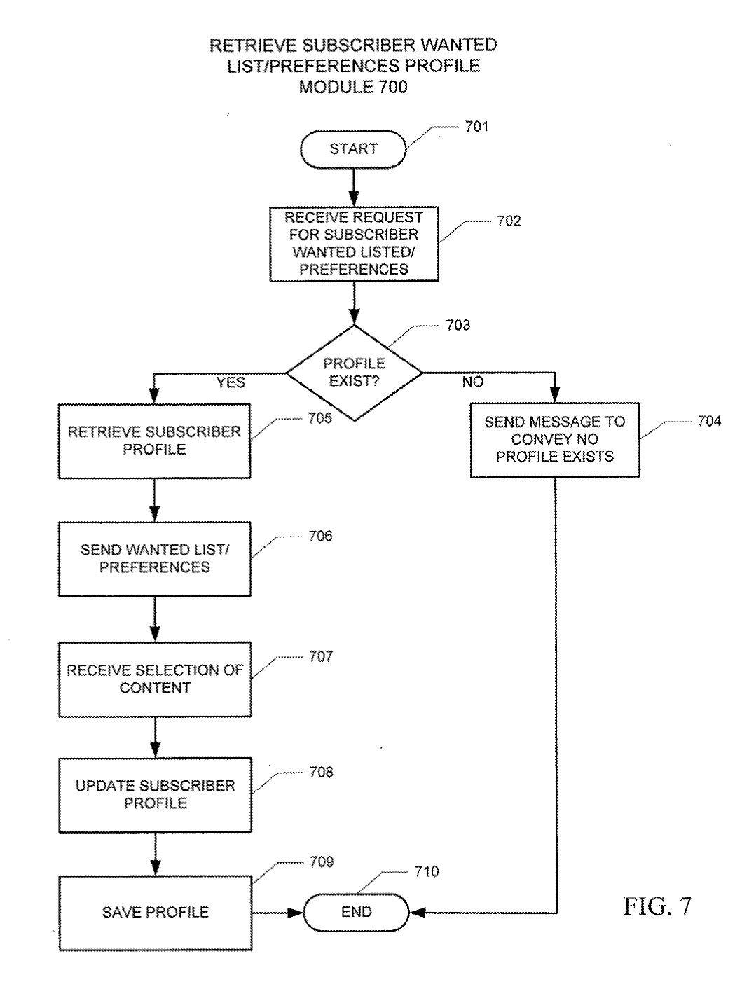

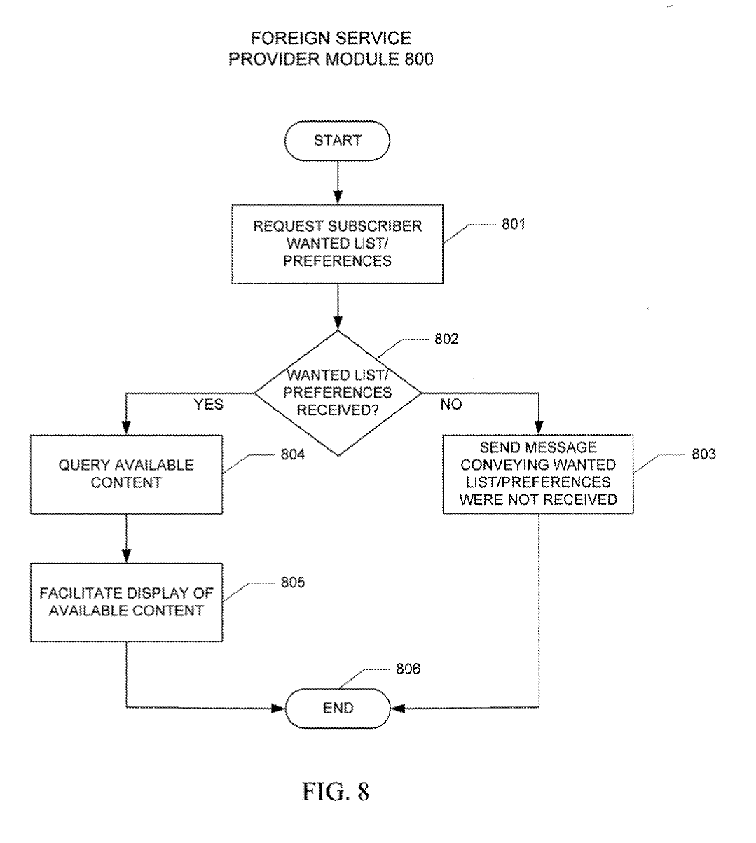

Thus, in various embodiments, the home service provider system 206 includes a retrieve subscriber wanted list/preferences (RSWP) module 700 that is adapted to facilitate retrieving a subscriber's profile and corresponding wanted list and/or preferences for a particular subscriber of the home service provider. Accordingly, FIG. 7 illustrates a flow diagram of the RSWP module 700 according to various embodiments. This flow diagram may correspond to the steps carried out by the processor 60 in the home service provider server 500 shown in FIG. 5 as it executes the module 600 in the server's RAM memory 67 according to various embodiments.

In Step 702, the RSWP module 700 receives the message that requests the subscriber's wanted list and/or preferences. In particular embodiments, the message identifies the subscriber by providing a unique identifier for the subscriber. Thus, in Step 703, the RSWP module 700 determines whether a subscriber profile exists for the particular subscriber. For instance, in one embodiment, the RSWP module 700 queries a listing of subscriber profiles using the subscriber identifier provided in the message. For example, the listing may be stored in a database that resides on storage media in the home service provider system 206. If the query returns one or more records associated with the subscriber from the listing than a profile exists for the subscriber. If the query returns no records (e.g., an empty record set) than a profile does not exist for the subscriber.

If the RSWP module 700 determines a profile does not exist for the subscriber, the module 700 in various embodiments sends a message to the foreign service provider that conveys that the subscriber does not have a wanted list and/or preferences, shown as Step 704. Thus, returning to the example, in particular embodiments, the RSWP module 700 sends a message over the Internet 205 to the foreign service provider system 204. In response, the foreign service provider system 204 sends information (e.g., a message) over the foreign service provider's distribution network 202 to the set-top box 201 located at the friends house. The set-top box 201 then causes a message to be displayed to the subscriber informing him or her that a wanted list and/or preferences could not be obtained for the subscriber.

If the RSWP module 700 determines a profile does exist for the subscriber, the RSWP module 700 retrieves the subscriber's profile in Step 705. For instance, in particular embodiments, the query may return the subscriber's profile or the query may return a storage location for the subscriber's profile. In the instances in which the query returns a storage location for the subscriber's profile, the RSWP module 700 retrieves the subscriber's profile from the storage location.

In Step 706, the RSWP module 700 sends information on the subscriber's wanted list and/or preferences to the foreign service provider. Thus, in various embodiments, the RSWP module 700 reads the subscriber's wanted list and/or preferences from the profile and sends information on the wanted list and/or preferences in a message to the foreign service provider system 204. In particular embodiments, this may entail the RSWP module 700 sending the message over the Internet 205 to the foreign service provider system 204.

In response, the foreign service provider system 204 receives the information on the wanted list and/or preferences and queries the available content through the foreign service provider based on the subscriber's wanted list and/or preferences. For example, the subscriber's wanted list may include the Harry Potter movies (that is, the list may include identifiers for each Harry Potter movie). The foreign service provider system 204 queries the available content through the foreign service provider to determine whether any of the Harry Potter movies are available. For instance, the foreign service provider system 204 may query the foreign service provider's programming guide and/or VOD library to determine whether any of the Harry Potter movies are available through the foreign service provider's scheduled programming and/or through its VOD services.

Further, the foreign service provider system 204 may query the foreign service provider's programming guide and/or VOD library based on the subscriber's preferences. For example, the subscriber's preferences may indicate that the subscriber has indicated that he or she likes to watch comedies and/or may indicate that the subscriber has viewed a number of programs considered comedies. Thus, the foreign service provider system 204 may query the programming guide and/or VOD library to identify programming that falls in the category of comedy. In addition, the foreign provider system 204 in various embodiments may also consider characteristics of the content identified on subscriber's wanted list. For example, the foreign service provider system 204 may also look for programming similar to the Harry Potter movies (e.g., programming that falls into the same category as the Harry Potter movies), such as the Goonies or the Neverending Story.

Once the foreign service provider system 204 has identified content available through the foreign service provider based on the subscriber's wanted list and/or preferences, the foreign service provider system 204 sends a listing of the available content over the foreign service provider's distribution network to the set-top box 201 located at the subscriber's friend's home. The set-top box 201 receives the listing and causes the listing to be displayed to the subscriber. For example, in one embodiment, the set-top box 201 provides a listing on the available content on one or more menu screens that are displayed on the television being viewed by the subscriber. The one or more menu screens provide information on how to view the listed content. For instance, the menu screens may indicate that a particular content is scheduled to be played on a broadcast channel at eight o'clock that evening and/or a particular content may be ordered through the foreign service provider's VOD service.

In another example, the set-top box 201 provides a menu of the available content that is displayed on the television being viewed by the subscriber and the subscriber selects a particular content from the menu via one or more buttons on a remote control in communication with the set-top box 201. In this particular example, the set-top box 201 sends the selection over the distribution network 202 to the foreign service provider system 204 and the system 204 facilitates streaming the selected content to the set-top box 201 so that the subscriber may view the content (e.g., similar to a typical VOD service).

Further, in various embodiments, the foreign service provider system 204 may send the subscriber's selection back to the home service provider. For instance, the subscriber may select a particular item of content to view from the listing and the foreign service provider system 204 sends a message identifying the particular item of content over the Internet 205 to the home service provider system 206 (e.g., sends a message to the home service provider system 206 that includes an identifier identifying a Harry Potter movie selected by the subscriber to view through the foreign service provider).

Returning to FIG. 7, in these particular embodiments, the RSWP module 700 residing on the home service provider system 206 receives the selection of the content, shown as Step 707. In response, the RSWP module 700 may update the subscriber's profile based on the subscriber's selection, shown as Step 708. For instance, if the subscriber has selected a particular content listed on the subscriber wanted list, the RSWP module 700 may remove the content (e.g., content title and/or identifier) from the wanted list. In other instances, the RSWP module 700 may add and/or modify the subscriber's preferences based on the selection. Once the RSWP module 700 has updated the subscriber's profile, the module 700 saves the subscriber profile, shown as Step 709.

As a result, the subscriber is able to view and request available content through a foreign service provider based on a roaming wanted list and/or preferences that that are used to identify available content through the foreign service provider. Thus, the subscriber visiting his or her friend in Chicago may be able to determine whether the friend's service provider may have any programming of interest to the subscriber.

### Foreign Service Provider Module

As described above, in various embodiments, the foreign service provider system 204 queries the content available through the foreign service provider to identify content based on the subscriber's wanted list and/or preferences. Thus, in various embodiments, the foreign service provider system 204 includes a foreign service provider (FSP) module 800 that is adapted to facilitate identifying content based on the subscriber's wanted list and/or preferences. Accordingly, FIG. 7 illustrates a flow diagram of the FSP module 800 according to various embodiments. This flow diagram may correspond to the steps carried out by a processor in a server residing in the foreign service provider system 204 and/or a processor residing on the set-top box 201 as it executes the module 800 in the server's and/or set-top box's RAM memory according to various embodiments.

As previously described, in various embodiments, the subscriber accesses the VOD service of the foreign service provider on a set-top box 201 and invokes the VOD service by selecting one or more buttons on a remote control in communication with the set-top box 201. As described, the VOD service may include an option that allows for the subscriber to retrieve his or her wanted list and/or preferences and to have the foreign service provider identify content available through its system 204 based on the subscriber's wanted list and/or preferences. Thus, the subscriber invokes the option and the option may request the subscriber to enter information to identify the subscriber and the subscriber's home service provider. In response, the set-top box 201 sends a message over the foreign service provider's distribution network 202 to the foreign service provider system 204.

In Step 801, the FSP module 800 residing in the foreign service provider system 204 receives the message and requests the subscriber's wanted list and/or preferences from the subscriber's home service provider. For instance, in one embodiment, the FSP module 800 identifies the subscriber's home service provider based on information provided in the message received from the set-top box 201 and sends a request over the Internet 205 to the home service provider system 206. As previously described, the home service provider system 206 determines whether the subscriber has a wanted list and/or preferences and forwards an appropriate response back to the foreign service provider system 204 (e.g., the home service provider system 206 sends either information on the subscriber's wanted list and/or preferences or a message indicating that the subscriber does not have a wanted list and/or preferences).

In response, the FSP module 800 determines whether the subscriber has a wanted list and/or preferences in Step 802. For instance, if the FSP module 800 receives information on the subscriber's wanted list and/or preferences from the home service provider system 206, the FSP module 800 determines the subscriber has a wanted list and/or preferences. In contrast, if the FSP module 800 receives a message from the home service provider system 206 that indicates the subscriber does not have a wanted list and/or preferences, the FSP module 800 determines the subscriber does not have a wanted list and/or preferences.

If the ESP module 800 determines that a wanted list and/or preferences are not available for the subscriber, the FSP module 800 sends a message conveying that a wanted list and/or preferences were not available, shown as Step 803. For instance, in one embodiment, the FSP module 800 sends a message over the foreign service provider's distribution network 202 to the set-top box 201 and the set-top box 201 facilitates displaying a message to the subscriber informing him or her that a wanted list and/or preferences are not available for the subscriber.

If the FSP module 800 determines that a wanted list and/or preferences are available for the subscriber, the FSP module 800 queries the available content through the foreign service provider (e.g., broadcast programming and/or VOD programming) to identify content based on the subscriber's wanted list and/or preferences, shown as Step 804. Thus, as previous described, in one embodiment, the FSP module 800 queries the programming guide and/or VOD library for the foreign service provider 800 based on the subscriber's wanted list and/or preferences. For instance, returning to the example, the FSP module 800 queries the programming guide and/or VOD library to identify any Harry Potter movies that may be available through the foreign service provider.

Once the FSP module 800 has identified the available content based on the subscriber's wanted list and/or preferences, in Step 805, the FSP module 800 facilitates displaying the available content to the subscriber. For instance, in one embodiment, the FSP module 800 sends a message that includes information on the available content (e.g., content titles and/or identifiers) over the foreign provider's distribution network 202 to the set-top box 201. In response, the set-top box 201 facilitates displaying the available content on the television being viewed by the subscriber. As previously described, the subscriber may then select a particular item of content from the available content to view.

As discussed above, in particular embodiments, the FSP module 800 may reside on the set-top box 201 as opposed to the foreign service provider's system. In these particular embodiments, the FSP module 800 may obtain the listing of available content from the foreign service provider system 204 or query a local version of the foreign service provider's programming guide and/or VOD library that resides on the set-top box 201. Thus, the FSP module 800 is configured to operate in a similar manner as if the module 800 was located on the foreign service provider system 204 and routes messages/requests over the foreign provider's distribution network 202, through the foreign service provider system 204, to the home service provider system 206.

In addition, in various embodiments, the FSP module 800 may receive the subscriber's wanted list and/or preferences from a device 210 used by the subscriber (e.g., client model). Thus, in these particular embodiments, the FSP module 800 may send the request for the subscriber's wanted list and/or preferences to the subscriber's device 210 (such as the subscriber's cell phone). For instance, in various embodiments, the FSP module 800 may send the request directly to the device 210 over such communication media as Bluetooth®, infrared, and/or Wi-Fi®. Where in other embodiments, the FSP module 800 may send the request to the device 210 by routing the request through the foreign service provider system 204, over the Internet 205, to the subscriber's wireless provider's system 209.

Yet, in other embodiments, the FSP module 800 may not send a request at all for the subscriber's wanted list and/or preferences. Instead, in these embodiments, the subscriber's device initiates the processing by transmitting the subscriber's wanted list and/or preferences to the set-top box 201 and/or foreign service provider system 204 and corresponding FSP module 800.

### Mobile Device Module

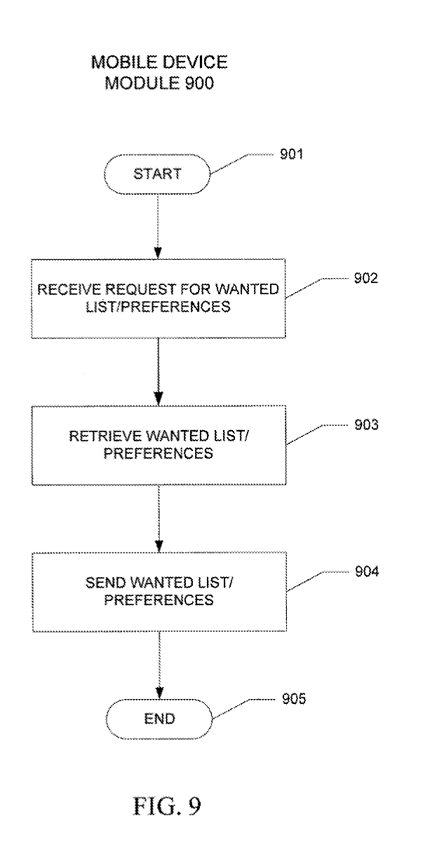

As previously described, in various embodiments, a device 210 may be used by the subscriber (such as the subscriber's cell phone) to transmit the subscriber's wanted list and/or preferences to set-top box 201 and/or to the foreign service provider system 204. Accordingly, FIG. 9 illustrates a flow diagram of a mobile device module 900 according to various embodiments. In particular embodiments, this mobile device module 900 may be an application that is downloaded onto the subscriber's device 210. For instance, the mobile device module 900 may be an application provided through iTunes® for an iPhone®. In other embodiments, the module 900 may be pre-installed on the device 210 prior to the subscriber purchasing the device. Thus, the flow diagram depicted in FIG. 9 may correspond to the steps carried out by a processor residing in the device 210 as it executes the module 900 in the device's RAM memory according to various embodiments.

In various embodiments, the mobile device module 900 may be configured to communicate directly with the set-top box 201. For instance, in one embodiment, the module 900 communicates with the set-top box 201 via infrared sensors that are found on many typical set-top boxes 201. In other embodiments, the module 900 may communicate with the set-top box 201 via other communication channels, such as Bluetooth® or Wi-Fi®. Thus, in particular embodiments, equipment and programming to provide these capabilities may need to be included along with the set-top box 201.

In particular embodiments, the set-top box 201 may initiate the process by sending a request to the subscriber's device 210 for the subscriber's wanted list and/or preferences. Thus, in Step 902, the mobile, device module 900 residing on the subscriber's device receives the request. However, in other embodiments, the subscriber may initiate the process by bring up an interface associated with the mobile device module 900 on his or her device 210 and provide input to the device 210 to send the subscriber's wanted list and/or preferences to the set-top box 201.

Therefore, in Step 903, regardless of whether the set-top box 201 or the subscriber's device 210 initiates the process, the mobile device module 900 retrieves the subscriber's wanted list and/or preferences. In one embodiment, this may entail the mobile device module 900 reading the subscriber's wanted list and/or preferences from local memory on the device 210. For example, the subscriber's wanted list and/or preferences may be stored in one or more files in memory on the device 210. In another embodiment, the mobile device module 900 requests the subscriber's wanted list and/or preferences from the subscriber's wireless provider. For instance, the subscriber's wireless provider either stores the subscriber's wanted list and/or preferences (e.g., subscriber's profile) or the wireless provider retrieves the subscriber's wanted list and/or preferences from the subscriber's home service provider. In this particular instance, the mobile device module 900 sends a request over the wireless provider's communication system to the wireless provider's system 209 and the system 209 sends back the subscriber's wanted list and/or preferences. Once the mobile device module 900 has retrieved the subscriber's wanted list and/or preferences, the module 900 sends the wanted list and/or preferences to the set-top box 201 directly (e.g., via infrared communication), shown as Step 904.

Further, in various embodiments, the mobile device module 900 may not communicate directly with the set-top box 201. For instance, in various embodiments, the module 900 may communicate with the foreign service provider (e.g., foreign service provider system 204 and/or set-top box 201) via the subscriber's wireless provider's network accessing an Internet gateway located on the foreign service provider's system 204. In this particular instance, the mobile device module 900 may receive the request for the subscriber's wanted list and/or preferences and/or may send the subscriber's wanted list and/or preferences over the wireless provider's network. For example, the mobile device module 900 may send the subscriber's wanted list and/or preferences over the wireless provider's network to the wireless provider's system 209. In response, the wireless provider's system 209 may send the wanted list and/or the preferences over the Internet 205 to the foreign provider system 206. The foreign provider system 206 may or may not then forward the wanted list and/or the preferences to the set-top box 201.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

What is claimed is:

1. A system for providing a roaming video wanted list for a subscriber of a first video service provider to a second video service provider, the roaming video wanted list comprising information identifying at least one of video content the subscriber has identified an interest in viewing and video content predicted the subscriber will have an interest in viewing, the system comprising:
memory; and
a processor adapted to:
(a) receive a request comprising identification information for the subscriber that is received over a communication network from a system of the second video service provider; and
(b) in response to receiving the request:
(1) retrieve from the memory the roaming video wanted list; and
(2) send at least a part of the information from the roaming video wanted list over the communication network to the system of the second service provider.

2. The system of claim 1, wherein the processor is adapted to:
receive a selection of video content made by the subscriber that is received over the communication network from the system of the second video service provider, the selection of video content comprising video content that is available through the second video service provider and based on the part of the information from the roaming video wanted list; and
update the information for the roaming video wanted list based on the selection of video content.

3. The system of claim 1, wherein the request comprises a username that identifies the subscriber.

4. The system of claim 1, wherein the processor updates the information from the roaming video wanted list by removing the selection of video content from the information.

5. The system of claim 1 further comprising:
an interface adapted to be used by the subscriber to enter information on video content the subscriber has an interest in viewing; and
the processor is further adapted to:
receive the information on video content the subscriber has an interest in viewing from the interface; and
store the information in the memory as the roaming video wanted list.

6. The system of claim 1, wherein the second video service provider is adapted to query video content available through the second video service provider to identify a set of video content based on the part of the information from the roaming video wanted list, and to present information on the set of video content to the subscriber.

7. A method for providing a roaming video wanted list for a subscriber of a first video service provider to a second video service provider, the roaming video wanted list comprising information identifying at least one of video content the subscriber has identified an interest in viewing and video content predicted the subscriber will have an interest in viewing, the method comprising the steps of:
(a) receiving a request comprising identification information for the subscriber over a communication network from a system of the second video service provider;
(b) in response to receiving the request:
(1) retrieving from memory the roaming video wanted list; and
(2) sending at least a part of the information from the roaming video wanted list over the communication network to the system of the second service provider.

8. The method of claim 7 further comprising the steps of:
(c) receiving a selection of video content made by the subscriber that is received over the communication network from the system of the second video service provider, the selection of video content comprising video content that is available through the second video service provider and based on the part of the information from the roaming video wanted list; and
(d) updating the information from the roaming video wanted list based on the selection of video content.

9. The method of claim 7, wherein the step of updating the information from the roaming video wanted list comprises removing the selection of video content from the information.

10. The method of claim 7 further comprising the steps of:
providing an interface used by the subscriber to enter information on video content the subscriber is interested in viewing;
receiving the information on video content the subscriber is interested in viewing from the interface; and
storing the information in the memory as the roaming video wanted list.

11. The method of claim 7, wherein the second video service provider is adapted to query video content available through the second video service provider to identify a set of video content based on the part of the information from the roaming video wanted list, and to present information on the set of video content to the subscriber.

12. A system for providing a roaming video wanted list for a subscriber of a first video service provider to a second video service provider, the roaming video wanted list comprising information identifying at least one of video content the subscriber has identified an interest in viewing and video content predicted the subscriber will have an interest in viewing, the system comprising:
a mobile device adapted to:
(a) retrieve from memory residing on the mobile device the roaming video wanted list; and
(b) send at least a part of the information from the roaming video wanted list over a wireless communication channel to a set-top box residing in a distribution network of the second service provider, wherein the set-top box causes display of information on a set of video content to the subscriber, the set of video content comprises video content available through the second video service provider and based on the part of the information from the roaming wanted list.

13. The system of claim 12, wherein the wireless communication channel is selected from a list consisting of: a Wi-Fi communication channel, an infrared communication channel, and a Bluetooth communication channel.

14. A method for providing a roaming video wanted list for a subscriber of a first video service provider to a second video service provider, the roaming video wanted list comprising information identifying at least one of video content the subscriber has identified an interest in viewing and video content predicted the subscriber will have an interest in viewing, the method comprising the steps of:
(a) retrieving from memory residing on a mobile device the roaming video wanted list; and
(b) sending at least a part of the information from the roaming video wanted list over a wireless communication channel to a set-top box residing in a distribution network of the second service provider, wherein the set-top box causes display of information on a set of video content to the subscriber, the set of video content comprises video content available through the second video service provider and based on the part of the information on the roaming wanted list.

15. The method of claim 14, wherein the wireless communication channel is selected from a list consisting of: a Wi-Fi communication channel, an infrared communication channel, and a Bluetooth communication channel.

16. A system for providing available video content through a first video service provider based on a roaming video wanted list for a subscriber of a second video service provider, the roaming video wanted list comprising information identifying at least one of video content the subscriber has identified an interest in viewing and video content predicted the subscriber will have an interest in viewing, the system comprising:
a processor adapted to:
(a) send a request for the roaming video wanted list over a communication network to a system of the second video service provider;
(b) receive at least a part of the information from the roaming wanted list over the communication network from the system of the second video service provider; and
(c) in response to receiving the part of the information from the roaming wanted list:
(1) identify a set of video content available through the first video service provider, the set of video content comprising video content based on the part of the information from the roaming video wanted list; and
(2) cause display of information for the set of video content to the subscriber, wherein the subscriber can select particular video content to view through the first video service provider from the information for the set of video content.

17. The system of claim 16, wherein the processor is adapted to cause display of the information for the set of video content by streaming the information for the set of video content over a distribution network of the first video service provider to a set-top box and the set-top box is adapted to cause display of the information for the video content on a television the subscriber is viewing.

18. The system of claim 16, wherein the processor is adapted to stream the particular video content selected by the subscriber over the distribution network to the set-top box and the set-top box is adapted to cause display of the particular video content on the television the subscriber is viewing.

19. The system of claim 16, wherein the processor is adapted to send information on the particular video content selected by the subscriber over the communication network to the system of the second video service provider.

20. A method for providing available video content through a first video service provider based on a roaming video wanted list for a subscriber of a second video service provider, the roaming video wanted list comprising information identifying at least one of video content the subscriber has identified an interest in viewing and video content predicted the subscriber will have an interest in viewing, the method comprising the steps of:
(a) sending a request for the roaming video wanted list over a communication network to a system of the second video service provider;
(b) receiving at least a part of the information from the roaming wanted list over the communication network from the system of the second video service provider; and
(c) in response to receiving the part of the information from the roaming wanted list:
(1) identifying a set of video content available through the first video service provider, the set of video content comprising video content based on the part of the information from the roaming video wanted list; and
(2) causing display of information for the set of video content by streaming the information for the set of video content over a distribution network of the first video service provider to a set-top box, the set-top box being adapted to cause display of the information for the set of video content on a television the subscriber is viewing, wherein the subscriber can select particular video content to view through the first video service provider from the information for the set of video content.

21. The method of claim 20 further comprising the step of streaming the particular video content selected by the subscriber over the distribution network to the set-top box, the set-top box being adapted to cause display of the particular video content on the television the subscriber is viewing.

22. The method of claim 20 further comprising the step of sending information on the particular video content selected by the subscriber over the communication network to the system of the second video service provider.
